(19) United States
(12) Patent Application Publication
(10) Pub. No.: US 2023/0337622 A1
(43) Pub. Date: Oct. 26, 2023

(54) ANIMAL TOILET

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 18/214,983

(22) Filed: Jun. 27, 2023

Related U.S. Application Data
(63) Continuation-in-part of application No. PCT/JP2021/038373, filed on Oct. 18, 2021.

(30) Foreign Application Priority Data
Jan. 18, 2021 (JP) 2021-005667

(51) Int. Cl. A01K 1/01

(52) U.S. Cl. CPC A01K 1/0103

(57) ABSTRACT

An animal toilet includes a partition portion, an upper space, and a lower space. The partition portion has a through hole allowing urine to pass therethrough. The upper space is present above the partition portion, and is a space in which a plurality of grains are disposed. The lower space is present below the partition portion, and is a space in which the urine that has passed through the through hole accumulates. A lower surface of the partition portion is provided with a hollow that catches an odor from the urine accumulating in the lower space.

### CROSS REFERENCE TO RELATED APPLICATION

This is a Continuation-in-part of International Application No. PCT/JP2021/038373 filed Oct. 18, 2021, which claims the benefit of Japanese Application No. 2021-005667 filed Jan. 18, 2021. The contents of these applications are hereby incorporated by reference in their entirety.

### TECHNICAL FIELD

The present invention relates to an animal toilet.

### BACKGROUND ART

A conventional animal toilet is disclosed, for example, in Patent Document 1. The animal toilet disclosed in Patent Document 1 includes a partition portion (drainboard), an upper space, and a lower space. A through hole that allows urine to pass therethrough is formed in the partition portion. The upper space is a part of the space in a box-shaped container (tray), the part being present above the partition portion. A plurality of low water absorptive grains are disposed in the upper space. The lower space is another part of the space in the container, the part being present below the partition portion. A water-absorbing sheet that absorbs urine is disposed in the lower space.

### CITATION LIST

### Patent Document

Patent Document 1: JP2003-180182 A

### SUMMARY OF INVENTION

### Technical Problem

In the animal toilet described above, urine excreted on the grains moves from the upper space to the lower space via the through hole of the partition portion after passing through gaps between the grains. The urine having moved to the lower space accumulates in the lower space in a state of being absorbed by the water-absorbing sheet. When a malodor is generated from the urine accumulating in the lower space, the odor tends to rise to the upper space via the through hole. This causes the malodor drifting outside the animal toilet.

### Solution to Problem

The present invention has been made in view of the above-described problem, and it is an object thereof to provide an animal toilet that makes a situation less likely to occur in which an odor of urine accumulating in a lower space rises to an upper space.

An animal toilet according to the present invention includes: a partition portion that has a through hole allowing urine to pass therethrough; an upper space in which a plurality of grains are disposed, the upper space being present above the partition portion; and a lower space in which the urine having passed through the through hole accumulates, the lower space being present below the partition portion. A lower surface of the partition portion is provided with a hollow that catches an odor from the urine accumulating in the lower space.

In this animal toilet, the lower surface of the partition portion is provided with the hollow that catches an odor from urine accumulating in the lower space. For this reason, even in a case where a malodor is generated from the urine accumulating in the lower space, at least a part of the odor can be caught by the hollow. Thus, it is possible to prevent the odor from rising to the upper space via the through hole.

### Advantageous Effects of Invention

According to the present invention, it is possible to implement an animal toilet that makes a situation less likely to occur in which an odor of urine accumulating in a lower space rises to an upper space.

### BRIEF DESCRIPTION OF DRAWINGS

FIG. 1 is an end view showing an embodiment of an animal toilet according to the present invention.

FIG. 2 is an end view showing a container 10.

FIG. 3 is a front view showing the container 10.

FIG. 4 is a plane view showing the container 10.

FIG. 5 is a perspective view showing a drawer portion 14.

FIG. 6 is a plane view showing a partition portion 20.

FIG. 7 is a bottom view showing the partition portion 20.

FIG. 8 is an end view taken along line VIII-VIII in FIG. 6.

FIG. 9 is an end view taken along line IX-IX in FIG. 6.

FIG. 10 is a bottom view for illustrating an inter-hole region R1, an inter-hole region R2, an internal region R3, and a peripheral region R4.

FIG. 11 is a bottom view for illustrating a modified example of a hollow 24.

FIG. 12 is a bottom view for illustrating another modified example of the hollow 24.

FIG. 13 is an end view for illustrating a modified example of the animal toilet in FIG. 1.

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

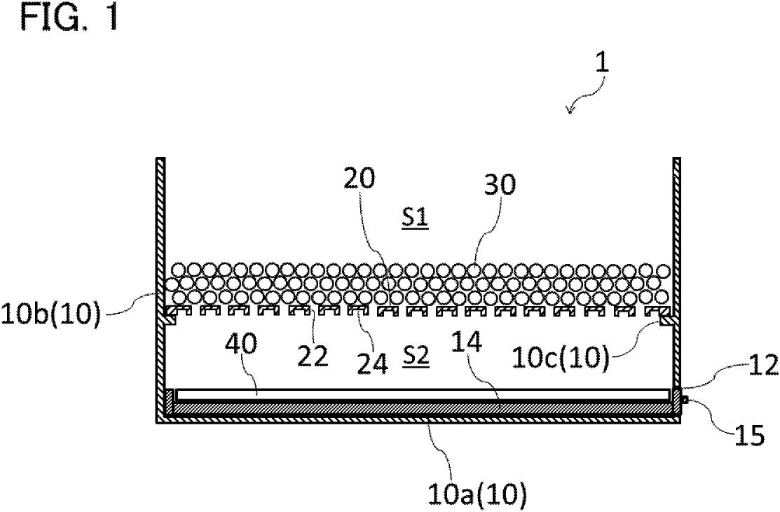

FIG. 1 is an end view showing an embodiment of an animal toilet according to the present invention. Referring to FIG. 1, an outline of the constitution of an animal toilet 1 will be described. The animal toilet 1 includes a container 10, a drawer portion 14, a partition portion 20, a plurality of grains 30, and a water-absorbing sheet 40. The container 10 has a bottom face part 10a and a side face part 10b, and is in a box shape. In the present embodiment, the container 10 is in an approximately rectangular parallelepiped shape. As a material of the container 10, for example, plastic such as polypropylene or polyethylene can be used.

The container 10 has an overhanging part 10c that is provided so as to overhang from the side face part 10b toward the inside of the container 10. The overhanging part 10c may be a projection or a projected rim. The overhanging part 10c may be formed integrally with the side face part 10b, or may be attached to the side face part 10b after being formed separately from the side face part 10b. The overhang length of the overhanging part 10c (the length in the direction perpendicular to the inner surface of the side face part 10b provided with the overhanging part 10c) is, for example, between 5 mm and 15 mm inclusive.

The drawer portion 14 is capable of being inserted in and extracted from the container 10 through an opening 12 formed in the side face part 10b. The drawer portion 14 houses the water-absorbing sheet 40. As a material of the drawer portion 14, for example, plastic such as polypropylene or polyethylene can be used.

The partition portion 20 is placed on the overhanging part 10c. The partition portion 20 is not fixed to the container 10. The partition portion 20 is detachable relative to the container 10. The partition portion 20 is in an approximately plate shape, and arranged in parallel with the bottom face part 10a. The partition portion 20 has a through hole 22 that allows urine to pass through the through hole 22. The partition portion 20 is provided at a position apart from both the water-absorbing sheet 40 and the upper end of the container 10. Thus, the partition portion 20 divides the inside of the container 10 vertically. That is, the partition portion 20 is disposed so as to divide the internal space of the container 10 into an upper space S1 and a lower space S2. The upper space S1 is present above the partition portion 20, and is a space in which the plurality of grains 30 are disposed. The lower space S2 is present below the partition portion 20, and is a space in which urine that has passed through the through hole 22 accumulates. In this way, the animal toilet 1 includes the upper space S1 and the lower space S2 that are separated by the partition portion 20. As a material of the partition portion 20, for example, plastic such as polypropylene or polyethylene can be used.

The plurality of grains 30 for treating excrement (urine) are disposed in the upper space S1. The plurality of grains 30 are disposed in the upper space S1 in a state of being laid on the partition portion 20. When the animal toilet 1 is used, the grains 30 directly receive excreted urine. The grains 30 have a water-repellent property. That is, the grains 30 have the property of not absorbing liquid such as urine at all, or hardly absorbing it.

The grains 30 having the water-repellent property require the water-repellent rate of 80 % or more measured by the following test. First, approximate 50 grams of the grains 30 (sample) are placed in a sieve with the inner diameter of 10 cm and the mesh size of 1 mm. An empty beaker is set under the sieve. Then, 30 ml of water is dripped on the sample over 10 seconds using a syringe with the inner diameter of its outer cylinder of 3 cm and the inner diameter of its cylinder tip of 4 mm (60 ml syringe manufactured by Terumo Corp.). After waiting 1 minute, the quantity of the water in the beaker is measured. The ratio of the measured water quantity with respect to the quantity of the dripped water (30 ml) shall be the water-repellent rate. That is, if the water quantity in the beaker is 24 ml or more, the water-repellent rate is 80 % or more, and therefore the grains 30 are found to have the water-repellent property. For reference, the water-repellent rate of general water-absorbing cat litter, which is commercially available, is about 5%.

The grains 30 are each formed in a granular shape. Examples of the granular shape include a sphere, column, and ellipsoid. The particle diameter of the grain 30 is, for example, between 5 mm and 20 mm inclusive. As used herein, the particle diameter is defined as the diameter of the minimum sphere that can include the grain 30. The grain 30 preferably contains an organic substance as its main material. As used herein, the main material refers to the material that accounts for the highest weight ratio in the grain 30, out of one or more materials constituting the grain 30. As the organic substance, for example, papers, used tea leaves, plastics, or bean curd lees can be used.

The papers refer to a material composed mainly of pulp. Examples of the papers include, in addition to ordinary paper, a vinyl chloride wallpaper classified product, photographic paper, release paper, fluff pulp, papermaking sludge, and pulp sludge. The vinyl chloride wallpaper classified product is obtained by removing part of polyvinyl chloride from vinyl chloride wallpaper containing paper and polyvinyl chloride. Examples of the plastics include, in addition to ordinary plastic, an aluminum deposited film, and a disposable diaper classified product (plastic obtained by classifying disposable diapers). The bean curd lees are preferably dried bean curd lees. These materials may be subjected to water repellency treatment.

The material(s) constituting the grain 30 may be only one material, or two or more materials. In the former case, the main material described above is the only material constituting the grain 30. In the latter case, the grain 30 is made of a mixture of the main material and other material(s). Gypsum is an example of the other material. Adding gypsum can enhance the water-repellent property of the grain 30. The quantity of gypsum is, for example, between 5 wt.% and 15 wt.% inclusive with respect to the entirety of the grain 30.

The grains 30 can be manufactured by, for example, the following method. First, granules that will serve as the grains 30 are formed by granulating a granulating material (the material(s) constituting the grains 30) with a granulation apparatus. As the granulation apparatus, for example, an extrusion granulator can be used. The granules may be subjected to water repellency treatment as needed. The water repellency treatment can be performed by, for example, coating the surfaces of the granules with a water repellent agent. In the case where the water repellency treatment is not performed, it is preferable that crevices are prevented from forming in the granules as much as possible by increasing the pressure that is applied to the granulating material during granulation. This is because the crevices serve as a path through which moisture such as urine enters inside the grains 30. Prior to the granulation, pretreatment such as pulverization, kneading, and adding water is performed on the granulating material as needed. Also, after the granulation, posttreatment such as sieving (sizing), and drying is performed as needed.

The water-absorbing sheet 40 is disposed in the lower space S2. In the present embodiment, the water-absorbing sheet 40 is disposed in the lower space S2 in a state of being housed in the drawer portion 14. The water-absorbing sheet 40 absorbs urine that has passed through the through hole 22 of the partition portion 20. That is, the urine having passed through the through hole 22 accumulates in the lower space S2 in a state of being absorbed by the water-absorbing sheet 40.

When the animal toilet 1 is used, urine excreted on the grains 30 flows downward, passing through gaps between the grains 30. The urine moves from the upper space S1 to the lower space S2 via the through hole 22 of the partition portion 20, and then is absorbed by the water-absorbing sheet 40.

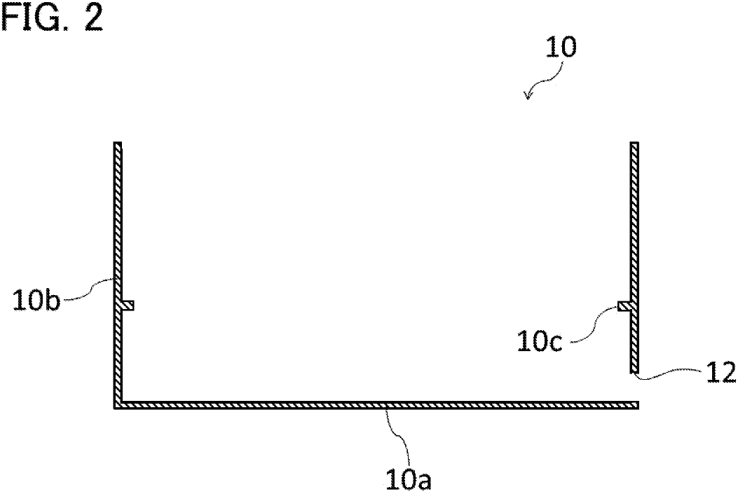

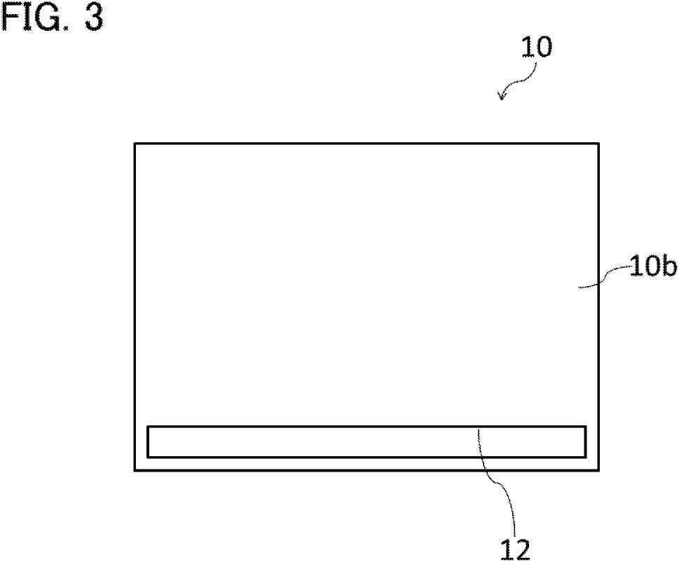

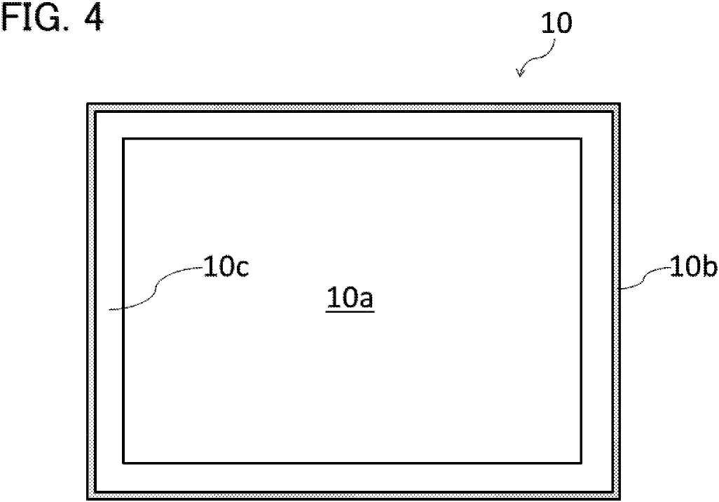

Hereinafter, referring to FIG. 2 to FIG. 10, the constitution of each portion of the animal toilet 1 will be described in detail. FIG. 2, FIG. 3 and FIG. 4 are, respectively, an end view, a front view and a plane view showing the container 10. As shown in FIG. 2 and FIG. 3, the opening 12 for inserting and extracting the drawer portion 14 is formed in the side face part 10b of the container 10. The opening 12 is located near the bottom face part 10a, and in a horizontally long rectangular shape. The length in the horizontal direction (right/left direction in FIG. 3) of the opening 12 is nearly equal to the breadth of the inside of the container 10, and is, for example. between 20 cm and 40 cm inclusive. The length in the vertical direction (top/bottom direction in FIG. 3) of the opening 12 is, for example, between 2 cm and 5 cm inclusive. Also, as shown in FIG. 4, the overhanging part 10c is composed of a projected rim that is provided annularly over the entirety of the inner surface of the side face part 10b in a plane view in the present embodiment.

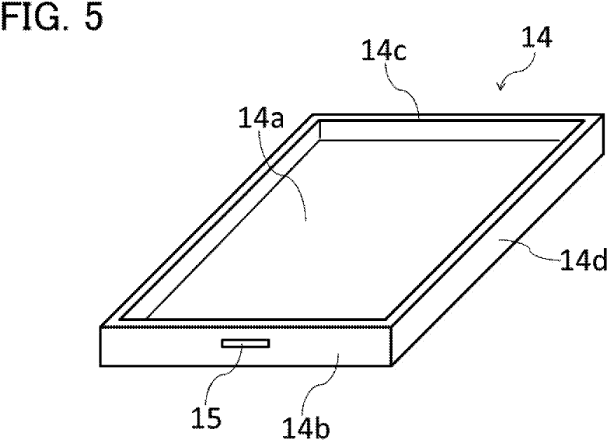

FIG. 5 is a perspective view showing the drawer portion 14. The drawer portion 14 has a bottom board 14a, a front board 14b, a rear board 14c, and a pair of side boards 14d. The size of the bottom board 14a is nearly equal to the size of the bottom face part 10a of the container 10. The front board 14b has nearly the same shape and size as the opening 12. A grip 15 is attached to the front board 14b.

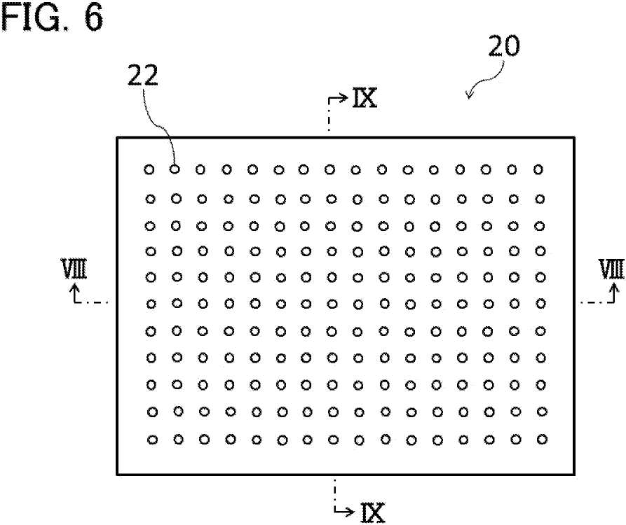

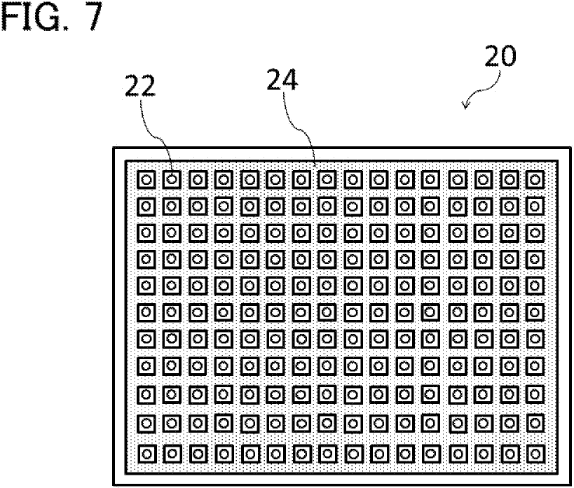

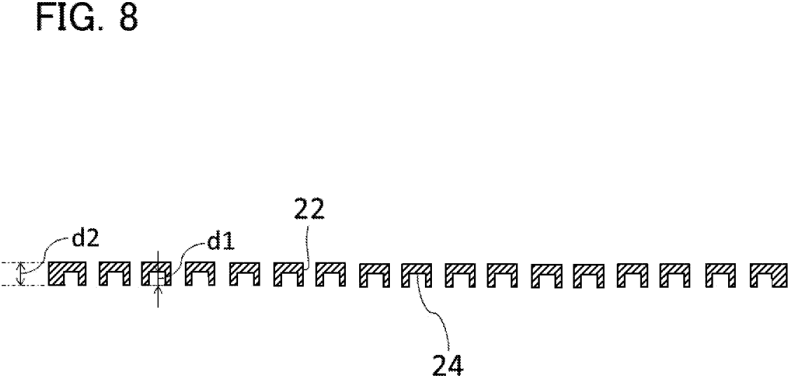

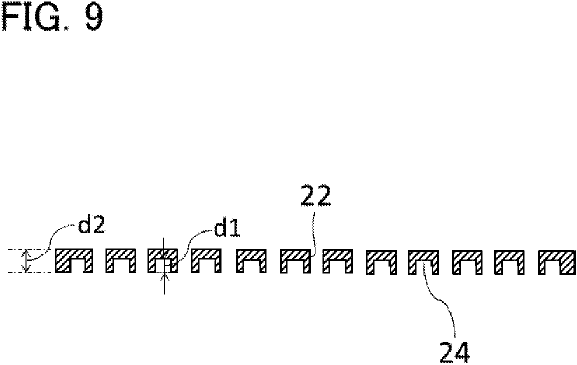

FIG. 6 and FIG. 7 are, respectively, a plane view and a bottom view showing the partition portion 20. That is. FIG. 6 and FIG. 7 show the upper surface (surface on the upper space S1 side) and the lower surface (surface on the lower space S2 side) of the partition portion 20, respectively. Also, FIG. 8 and FIG. 9 are end views taken along line VIII-VIII and line IX-IX in FIG. 6, respectively. The partition portion 20 is in an approximately rectangular shape in a plane view (see FIG. 6). As used herein, “approximately rectangular shape” means that the shape includes not only a rectangle but also a shape similar to a rectangle such as a round corner rectangle. The upper surface (except for a part in which the through hole 22 is provided) of the partition portion 20 in its entirety is a flat horizontal surface.

The partition portion 20 has a plurality of the through holes 22. In the descriptions below, “plurality of through holes 22” refers to all of the through holes 22 provided in the partition portion 20 unless otherwise indicated. The plurality of through holes 22 are arranged two-dimensionally in the partition portion 20. In detail, the plurality of through holes 22 are arranged two-dimensionally along a first direction (right/left direction in FIG. 6), and a second direction (top/bottom direction in FIG. 6) that intersects with the first direction. In the present embodiment, the second direction is the direction orthogonal to the first direction. That is, the plurality of through holes 22 are arranged in a square lattice pattern. The plane shape of each through hole 22 is a circle. Also, the diameter of each through hole 22 is constant with respect to the thickness direction (top/bottom direction in FIG. 8 and FIG. 9) of the partition portion 20. Therefore, each through hole 22 is composed of a columnar space. Each through hole 2 allows urine to pass therethrough, but does not allow the grain 30 to pass therethrough.

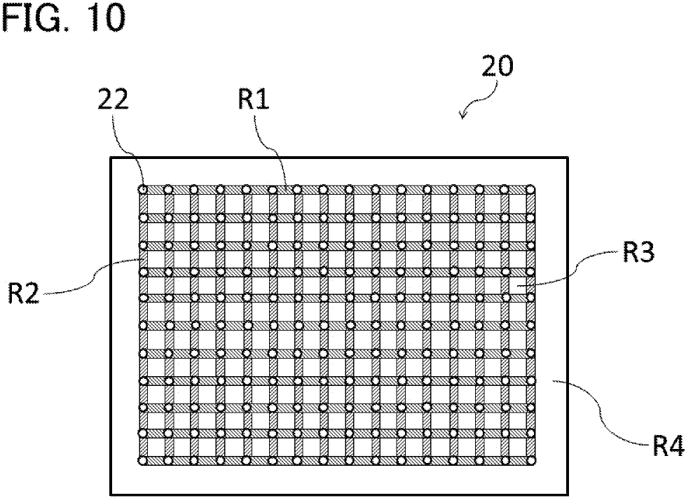

As shown in FIG. 10, the lower surface of the partition portion 20 includes an inter-hole region R1 (first inter-hole region), an inter-hole region R2 (second inter-hole region), an internal region R3, and a peripheral region R4. FIG. 10 shows the lower surface of the partition portion 20. However, a hollow 24 described below is not shown in FIG. 10. The inter-hole region R1 is the region between the through holes 22 adjacent along the first direction. The inter-hole region R2 is the region between the through holes 22 adjacent along the second direction. The width of each of the inter-hole regions R1, R2 is equal to the diameter of each through hole 22. The internal region R3 is the region surrounded by the inter-hole region R1 and the inter-hole region R2. In the present embodiment, the internal region R3 is in a rectangular shape. The peripheral region R4 is the region other than the inter-hole region R1, the inter-hole region R2, or the internal region R3 in the lower surface of the partition portion 20. The peripheral region R4 is a frame-shaped region along the edge of the partition portion 20. All through holes 22 are present inside the peripheral region R4.

As can be seen from FIG. 7, the lower surface of the partition portion 20 is provided with the hollow 24. The hollow 24 catches an odor from urine accumulating in the lower space S2. The partition portion 20 is thinned at the part in which the hollow 24 is provided. Therefore, the bottom part (the nearest part to the upper surface of the partition portion 20) of the hollow 24 is located above the lower end of the through hole 22. The lower surface of the partition portion 20 is provided with only one hollow 24. The hollow 24 is provided over the inter-hole region R1, the inter-hole region R2, the internal region R3, and the peripheral region R4. That is, the hollow 24 is present in all of the inter-hole region R1, the inter-hole region R2, the internal region R3, and the peripheral region R4.

The depth d1 (see FIG. 8 and FIG. 9) of the hollow 24 is preferably a quarter or more, and more preferably half or more of the thickness d2 of the partition portion 20. The thickness d2 is the thickness of the partition portion 20 at the part in which the hollow 24 is not provided, and is equal to the length of each through hole 22. The thickness d2 is, for example, between 5 mm and 20 mm inclusive. The depth d1 of the hollow 24 is constant with respect to the entirety of the hollow 24. That is, the bottom part of the hollow 24 in its entirety is a flat horizontal surface. In the lower surface of the partition portion 20, the area of the part in which the hollow 24 is provided is preferably larger than the area of the part in which the through hole 22 is provided (the total of the opening areas of the plurality of through holes 22). Also, the area ratio of the hollow 24 with respect to the partition portion 20 is preferably 25 % or more, and more preferably 50 % or more in a bottom view (see FIG. 7). As used herein, the area ratio of the hollow 24 with respect to the partition portion 20 refers to the ratio of the area of the part in which the hollow 24 is provided in the lower surface of the partition portion 20 with respect to the area of the entire lower surface (including the part in which the through hole 22 is provided).

The hollow 24 is apart from each through hole 22. Therefore, the hollow 24 is not continuous with the through hole 22. In the lower surface of the partition portion 20, the hollow 24 is preferably apart from each through hole 22 by 2 mm or more. The hollow 24 is also apart from the edge of the partition portion 20. For this reason, the hollow 24 is present in only a part of each region (the inter-hole region R1, the inter-hole region R2, the internal region R3, the peripheral region R4).

The effects of the animal toilet 1 will be described. In the animal toilet 1, the lower surface of the partition portion 20 is provided with the hollow 24 that catches an odor from urine accumulating in the lower space S2. For this reason, even in a case where a malodor is generated from the urine accumulating in the lower space S2, at least a part of the odor can be caught by the hollow 24. Thus, it is possible to prevent the odor from rising to the upper space S1 via the through hole 22. Accordingly, the animal toilet 1 is implemented that makes a situation less likely to occur in which an odor of urine accumulating in the lower space S2 rises to the upper space S1.

Enlarging the depth d1 of the hollow 24 makes the caught odor less likely to be released from the hollow 24. From this viewpoint, the depth d1 is preferably a quarter or more, and more preferably half or more of the thickness d2 of the partition portion 20. On the other hand, the depth d1 is too large, the strength of the partition portion 20 is likely to be insufficient. From this viewpoint, the depth d1 is preferably three quarters or less of the thickness d2.

In the case where in the lower surface of the partition portion 20, the area of the part in which the hollow 24 is provided is larger than the area of the part in which the through hole 22 is provided, it is advantageous for increasing the ratio of an odor that is caught by the hollow 24 (reducing the ratio of an odor that rises to the upper space S1 via the through hole 22).

Enlarging the area ratio of the hollow 24 with respect to the partition portion 20 makes a lot of odors more likely to be caught by the hollow 24. From this viewpoint, the area ratio of the hollow 24 with respect to the partition portion 20 in a bottom view is preferably 25 % or more, and more preferably 50 % or more. On the other hand, the area ratio is too large, the strength of the partition portion 20 is likely to be insufficient. From this viewpoint, the area ratio is preferably 75 % or less.

The hollow 24 is apart from the through hole 22. Isolating the hollow 24 from the through hole 22 in this way can prevent an odor caught by the hollow 24 from leaking to the upper space S1 via the through hole 22. Moreover, isolating the hollow 24 from the through hole 22 is advantageous for securing strength of the partition portion 20. From this viewpoint, in the lower surface of the partition portion 20, the hollow 24 is preferably apart from each through hole 22 by 2 mm or more. In the case where the partition portion 20 is made of plastic, it is particularly important to secure strength of the partition portion 20 sufficiently in this way.

The lower surface of the partition portion 20 is provided with only one hollow 24. In this case, there is an advantage that the hollow 24 easily spreads over a wide range of the lower surface of the partition portion 20, compared to a case where a plurality of the hollows 24 are provided.

The partition portion 20 has the plurality of through holes 22 that are arranged two-dimensionally along the first and second directions. Providing the plurality of through holes 22 in this way enables urine to move from the upper space S1 to the lower space S2 smoothly.

The hollow 24 is present in the internal region R3 of the lower surface of the partition portion 20. The internal region R3 is the region inside the four through holes 22 that are located at positions corresponding to the vertexes of a quadrangle. Providing the hollow 24 in this internal region R3 can prevent effectively an odor from rising to the upper space S1 via the through holes 22.

The hollow 24 is present in the peripheral region R4 of the lower surface of the partition portion 20. The peripheral region R4 is the region along the edge of the partition portion 20. Providing the hollow 24 in this peripheral region R4 can prevent effectively an odor from rising to the upper space S1 via the edge (gap between this edge and the container 10) of the partition portion 20.

The hollow 24 is present in all of the inter-hole region R1, the inter-hole region R2, the internal region R3, and the peripheral region R4. Thus, the hollow 24 can spread over a wide range of the lower surface of the partition portion 20.

Each grain 30 has a water-repellent property. In this case, most of urine excreted on the grains 30 is not absorbed by the grains 30, and passes through gaps between the grains 30. Thus, the urine can be smoothly guided to the partition portion 20.

The animal toilet 1 is provided with the container 10 that includes the internal space divided into the upper space S1 and the lower space S2 by the partition portion 20. In this case, it is possible to implement the animal toilet 1 including the upper space S1 and the lower space S2 with one container (the container 10). This is advantageous for simplifying the constitution of the animal toilet 1.

The partition portion 20 is not fixed to the container 10. In this case, the partition portion 20 can be attached to and detached from the container 10 easily.

The partition portion 20 is placed on the overhanging part 10c. Thus, the partition portion 20 can stay at a predetermined position in the container 10 without being fixed to the container 10.

The water-absorbing sheet 40 is disposed in the lower space S2. Thus, urine accumulating in the lower space S2 can be confined in the water-absorbing sheet 40. For this reason, it is possible to ease generation of malodors caused by the urine.

The animal toilet 1 is provided with the drawer portion 14 that is capable of being inserted in and extracted from the container 10. Thus, it is possible to easily carry out the work of replacing a used water-absorbing sheet 40 with a new one.

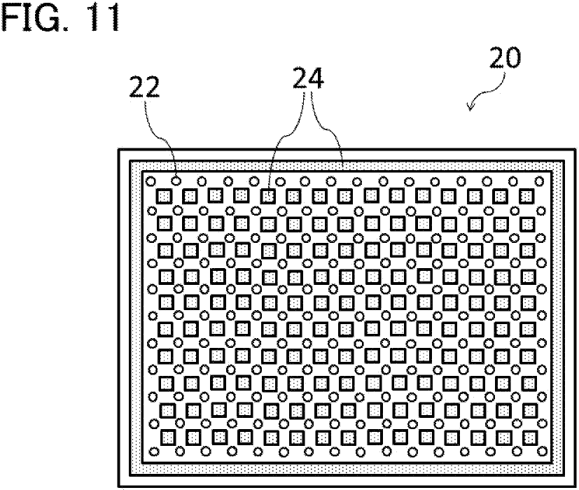

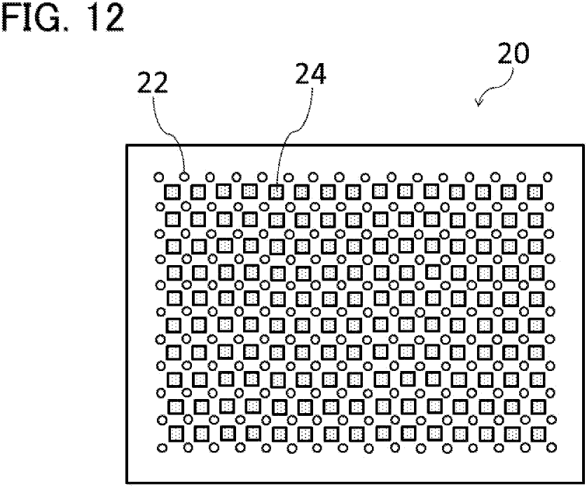

The present invention is not limited to the above-described embodiment, and various modifications can be made. In the above-described embodiment, an example is given in which the lower surface of the partition portion 20 is provided with only one hollow 24. However, the lower surface of the partition portion 20 may be provided with a plurality of the hollows 24 as shown, for example, in FIG. 11 and FIG. 12. In FIG. 11 and FIG. 12, the hollow 24 is not present in the inter-hole region R1 or the inter-hole region R2. In FIG. 11, the hollow 24 is present only in the internal region R3 and the peripheral region R4. In FIG. 12, the hollow 24 is present only in the internal region R3.

In the case where the plurality of hollows 24 are provided in this way, it is advantageous for securing strength of the partition portion 20, because the partition portion 20 is not thinned between the hollows 24. Moreover, the part between the through holes 22 is relatively weak in the partition portion 20. Therefore, not providing the hollow 24 in the inter-hole region R1 or the inter-hole region R2 is particularly advantageous for securing strength of the partition portion 20.

In the above-described embodiment, an example is given in which the plane shape of the through hole 22 is a circle. However, the plane shape of the through hole 22 is arbitrary, and may be, for example, a polygon such as a rectangle, or an ellipse.

In the above-described embodiment, an example is given in which the drawer portion 14 is provided. However, it is not essential to provide the drawer portion 14. In the case where the drawer portion 14 is not provided, the water-absorbing sheet 40 is disposed directly on the bottom face part 10a. In that case, the side face part 10b is not provided with the opening 12 naturally.

In the above-described embodiment, an example is given in which the water-absorbing sheet 40 is disposed in the lower space S2. However, it is not essential to dispose the water-absorbing sheet 40 in the lower space S2. In the case where the water-absorbing sheet 40 is not disposed, the drawer portion 14 is also not provided.

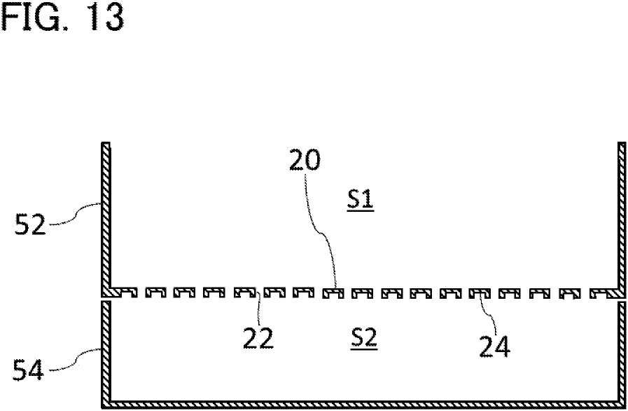

In the above-described embodiment, an example is given in which the upper space S1 and the lower space S2 are constituted by one container 10. However, a container 52 constituting the upper space S1 and a container 54 constituting the lower space S2 may be provided separately as shown, for example, in FIG. 13. In FIG. 13, the container 52 and the container 54 each have a bottom face part and a side face part, and are in a box shape. The container 52 is put on the container 54. Moreover, the bottom face part of the container 52 is the partition portion 20.

In the above-described embodiment, an example is given in which water-repellent grains are used as the grains 30. However, water-permeable grains may be used as the grains 30. The water-permeable grains are configured such that urine passes through the inside of the grains.

List of Reference Numerals

| | |
|---|---|
| 1 | Animal Toilet |
| 10 | Container |
| 10 a | Bottom Face Part |
| 10 b | Side Face Part |
| 10 c | Overhanging Part |
| 12 | Opening |
| 14 | Drawer Portion |
| 15 | Grip |
| 20 | Partition Portion |
| 22 | Through Hole |
| 24 | Hollow |
| 30 | Grain |
| 40 | Water-Absorbing Sheet |
| 52 | Container |
| 54 | Container |
| R1 | Inter-hole Region (First Inter-hole Region) |
| R2 | Inter-hole Region (Second Inter-hole Region) |
| R3 | Internal Region |
| R4 | Peripheral Region |
| S1 | Upper Space |
| S2 | Lower Space |

1. An animal toilet comprising:
a partition portion that has a through hole allowing urine to pass therethrough;
an upper space in which a plurality of grains are disposed, the upper space being present above the partition portion; and
a lower space in which the urine having passed through the through hole accumulates, the lower space being present below the partition portion,
wherein a lower surface of the partition portion is provided with a hollow that catches an odor from the urine accumulating in the lower space.

2. The animal toilet according to claim 1,
wherein a depth of the hollow is a quarter or more of a thickness of the partition portion.

3. The animal toilet according to claim 1,
wherein in the lower surface of the partition portion, an area of a part in which the hollow is provided is larger than an area of a part in which the through hole is provided.

4. The animal toilet according to claim 1,
wherein an area ratio of the hollow with respect to the partition portion is 25 % or more.

5. The animal toilet according to claim 1,
wherein the hollow is apart from the through hole.

6. The animal toilet according to claim 5.
wherein in the lower surface of the partition portion, the hollow is apart from the through hole by 2 mm or more.

7. The animal toilet according to claim 1,
wherein the lower surface of the partition portion is provided with the only one hollow.

8. The animal toilet according to claim 1,
wherein the lower surface of the partition portion is provided with a plurality of the hollows.

9. The animal toilet according to claim 1,
wherein the partition portion has a plurality of the through holes that are arranged two-dimensionally along a first direction, and a second direction intersecting with the first direction, and
the lower surface of the partition portion includes a first inter-hole region that is a region between the through holes adjacent along the first direction, a second inter-hole region that is a region between the through holes adjacent along the second direction, an internal region that is a region surrounded by the first and second inter-hole regions, and a peripheral region that is a region other than the first inter-hole region, the second inter-hole region, or the internal region.

10. The animal toilet according to claim 9,
wherein the hollow is not present in the first or second inter-hole region.

11. The animal toilet according to claim 9,
wherein the hollow is present in the internal region.

12. The animal toilet according to claim 9.
wherein the hollow is present in the peripheral region.

13. The animal toilet according to claim 9,
wherein the hollow is present in all of the first and second inter-hole regions, the internal region, and the peripheral region.

14. The animal toilet according to claim 1,
wherein the partition portion is made of plastic.

15. The animal toilet according to claim 1,
wherein each of the grains has a water-repellent property.

16. The animal toilet according to claim 1, further comprising:
a box-shaped container that has a bottom face part and a side face part,
wherein the partition portion is disposed so as to divide an internal space of the container into the upper space and the lower space.

17. The animal toilet according to claim 16,
wherein the partition portion is not fixed to the container.

18. The animal toilet according to claim 17,
wherein the container has an overhanging part that is provided so as to overhang from the side face part toward an inside of the container, and
the partition portion is placed on the overhanging part.

19. The animal toilet according to claim 16, further comprising:
a water-absorbing sheet that is disposed in the lower space, and absorbs the urine having passed through the through hole.

20. The animal toilet according to claim 19, further comprising:
a drawer portion that houses the water-absorbing sheet,
wherein an opening is formed in the side face part of the container, and
the drawer portion is capable of being inserted in and extracted from the container through the opening.
